(19) United States
(12) Patent Application Publication
(10) Pub. No.: US 2026/0059121 A1
(43) Pub. Date: Feb. 26, 2026

(54) VQ BASED TRANSFORM COEFFICIENT COMPENSATION

(71) Applicant: Tencent America LLC, Palo Alto, CA (US)

(72) Inventors: Yifan WANG, Palo Alto, CA (US); Roman CHERNYAK, Santa Clara, CA (US); Lien-Fei CHEN, Palo Alto, CA (US); Shan LIU, San Jose, CA (US); Ziyue XIANG, Palo Alto, CA (US); Biao WANG, San Jose, CA (US); Yonguk YOON, Palo Alto, CA (US)

(73) Assignee: Tencent America LLC, Palo Alto, CA (US)

(21) Appl. No.: 19/306,879

(22) Filed: Aug. 21, 2025

Related U.S. Application Data
(60) Provisional application No. 63/686,518, filed on Aug. 23, 2024.

(51) Int. Cl. H04N 19/18; H04N 19/124; H04N 19/176; H04N 19/46

(52) U.S. Cl. CPC H04N 19/18; H04N 19/124; H04N 19/176; H04N 19/46

(57) ABSTRACT

Some aspects of the disclosure provide a method of video decoding. For example, a coded video bitstream is received. The coded video bitstream includes coded information of a current block in a picture. The coded information includes quantized transform coefficients for a residual block of the current block, the residual block is transformed from a spatial domain to transform coefficients in a spectrum domain, the transform coefficients are quantized into the quantized transform coefficients. A search key is formed based on the coded information of the current block. A codebook is searched by using the search key to obtain a compensation term. The codebook includes a plurality of codewords, each codeword of the plurality of codewords includes a key and a predetermined compensation term associated with the key. The current block is reconstructed based on the compensation term.

### INCORPORATION BY REFERENCE

The present application claims the benefit of priority to U.S. Provisional Application No. 63/686,518, filed on Aug. 23, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. For example, a coded video bitstream is received. The coded video bitstream includes coded information of a current block in a picture. The coded information includes quantized transform coefficients for a residual block of the current block, the residual block is transformed from a spatial domain to transform coefficients in a spectrum domain, the transform coefficients are quantized into the quantized transform coefficients. A search key is formed based on the coded information of the current block. A codebook is searched by using the search key to obtain a compensation term. The codebook includes a plurality of codewords, each codeword of the plurality of codewords includes a key and a predetermined compensation term associated with the key. The current block is reconstructed based on the compensation term.

An aspect of the disclosure provides a method of video encoding. For example, a residual block of a current block in a current picture is transformed from a spatial domain to transform coefficients in a spectrum domain. A quantization is performed on the transform coefficients to obtain quantized transform coefficients. The quantized transform coefficients are encoded into coded information of the current block in a bitstream. A search key is formed based on the coded information of the current block. A codebook is searched using the search key to obtain a compensation term, the codebook includes a plurality of codewords, each codeword of the plurality of codewords includes a key and a predetermined compensation term associated with the key. A sequence of pictures including the current picture are encoded into the bitstream according to a reconstructed current block, the reconstructed current block is reconstructed based on the compensation term.

Another aspect of the disclosure provides a method of processing visual media data is provided. In the method, a conversion between a visual media file and a bitstream of visual media data is performed according to a format rule. In an example, the bitstream carries coded information of a current block in a picture. The coded information includes quantized transform coefficients for a residual block of the current block, the residual block is transformed from a spatial domain to transform coefficients in a spectrum domain, the transform coefficients are quantized into the quantized transform coefficients. The format rule specifies that a search key is formed based on the coded information of the current block; a codebook is searched by using the search key to obtain a compensation term, the codebook including a plurality of codewords, each codeword of the plurality of codewords includes a key and a predetermined compensation term associated with the key; and the current block is reconstructed based on the compensation term.

Aspects of the disclosure also provide an apparatus for video encoding. The apparatus for video encoding includes processing circuitry configured to implement any of the described methods for video encoding.

Aspects of the disclosure also provide an apparatus for video decoding. The apparatus for video decoding includes processing circuitry configured to implement any of the described methods for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system in some examples.

FIG. 2 is a schematic illustration of an example of a block diagram of a decoder in some examples.

FIG. 3 is a schematic illustration of an example of a block diagram of an encoder in some examples.

FIG. 4 shows an example of a framework for using a codebook for transform coefficient compensation in some embodiments.

FIG. 5 shows a flow chart outlining a process according to an aspect of the disclosure.

FIG. 6 shows a flow chart outlining a process according to an aspect of the disclosure.

FIG. 7 is a schematic illustration of a computer system in accordance with an aspect.

### DETAILED DESCRIPTION

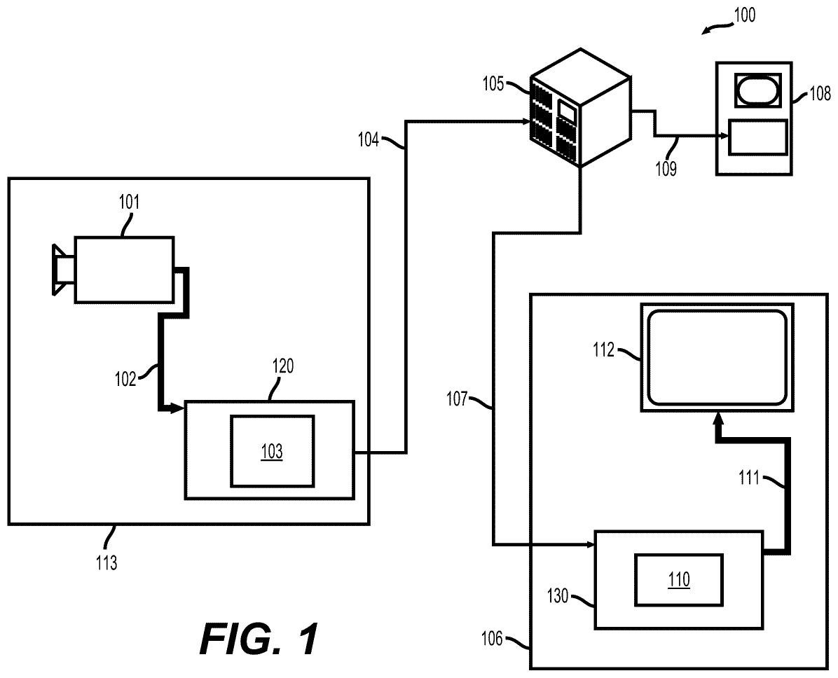

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

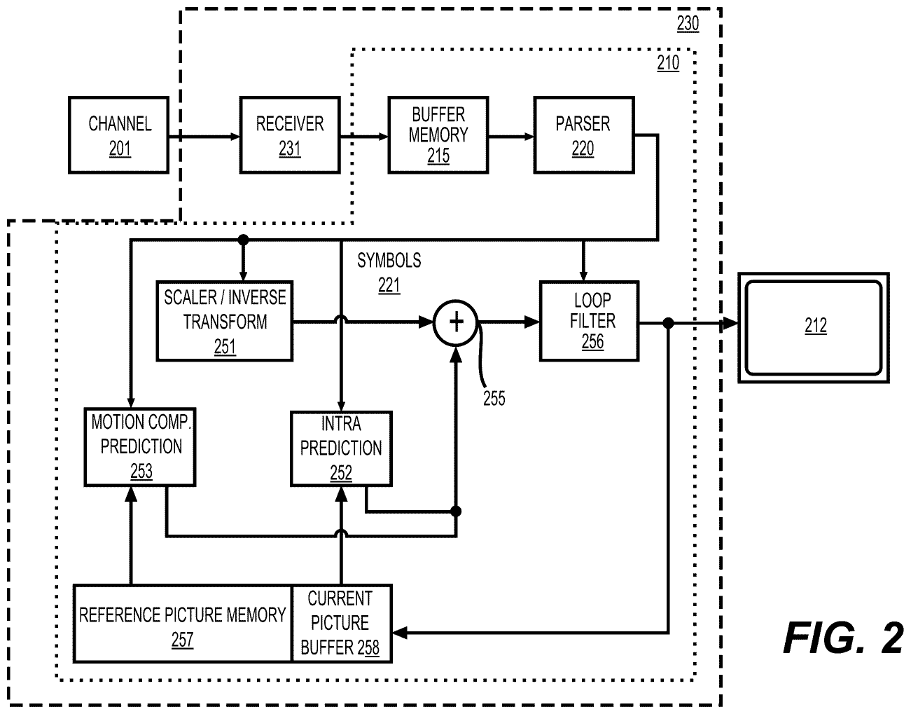

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

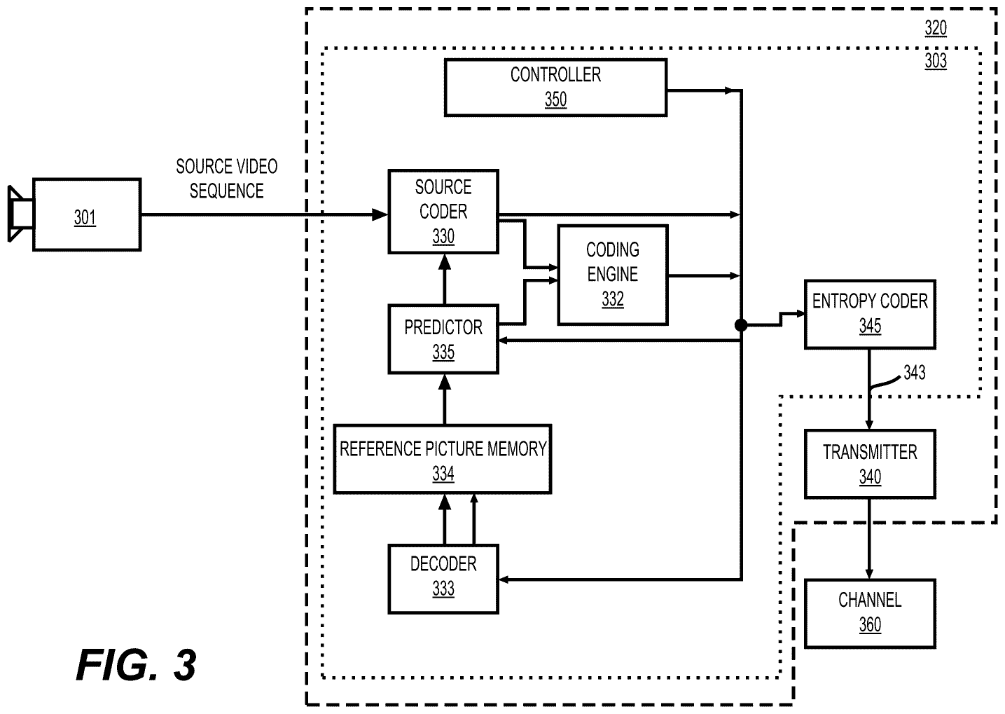

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the disclosure provide techniques for transform coefficient compensation, the techniques can be used to reconstruct transform coefficients, and improve image quality for images and videos. In some examples, a codebook with pretrained codewords are available to both encoder and decoder. The codebook includes a plurality of codewords, each codeword of the plurality of codewords includes a key and a predetermined compensation term associated with the key. A search key is formed based on information of a current block available at the encoder and decoder. The codebook is searched by the search key to obtain a compensation term, and the current block is reconstructed based on the compensation term.

In some aspects, image and video coding standards can be implemented by a hybrid video coding framework. In some examples, a hybrid video coding framework can include various modules, such as intra prediction module, inter prediction module, transform module, quantization module, in-loop filter module and the like.

In some video codecs (e.g., ECM), zero out can be applied to transform coefficients when block size is large, zero out can reduce coding (encoding/decoding) complexity. For example, during the zero out process, certain transform coefficients, such as for relatively high frequencies (e.g., higher than certain predetermined threshold) or for less significant frequencies that have relatively small values (e.g., smaller than certain predetermined threshold) and contribute less to the perceived quality of the reconstructed image or video, are set to zeros.

Further, in some examples, after performing quantization on the transform coefficients, the tail part of the transform coefficients (e.g., the transform coefficients for the higher-frequencies) is likely to be zeros due to the quantization. In an example, a last significant position (e.g., last non zero quantized transform coefficient) in a sequence of the quantized transform coefficients can be located and further coding is performed accordingly. For example, the zeros in the tail part can be omitted to save coding bits and improve coding efficiency.

The zero out of the transform coefficients and zeros of the tail part of quantized transform coefficients can introduce loss to the reconstruction of video or images.

Some aspects of the present disclosure provide techniques for vector quantization (VQ) based transform coefficient compensation. The techniques in the present disclosure can be used separately or combined in any order. Further, each of the techniques can be implemented by processing circuitry (e.g., one or more processors or one or more integrated circuits). In an example, the one or more processors execute a program that is stored in a non-transitory computer-readable medium. The techniques can be implemented in various video coding standards, such as H264, H265, H266 (VVC), AV 1, AVS, and the like.

In some aspects, transform can be generalized, such as represented in Eq. (1):

$$tX = X \cdot {K}^{T} \qquad Eq . ( 1 )$$

where tX denotes the transform coefficients (also referred to as spectrum domain coefficients) in a spectrum domain (also referred to as frequency domain), X denotes the spatial domain residual block, K^{T} denotes the (forward) transform kernel and K denotes the inverse transform kernel. In some examples, tX can be quantized at the encoder side to generate quantized transform coefficients (also referred to as quantized spectrum domain coefficients) that are denoted as tX_{q}. At the decoder side, the quantized transform coefficients tX_{q} can be decoded from a bitstream (also referred to as coded video bitstream and the like) and de-quantized at the decoder side to generate dequantized transform coefficients (also referred to as dequantized spectrum domain coefficients) denoted by tX′, such as shown by Eq. (2) and Eq. (3). The inverse transform is performed on the dequantized transform coefficients to get the reconstructed spatial domain residual (also referred to as reconstructed residual block) denoted by iX, such as shown in Eq. (4)

$${tX}_{q} = ( Quant ( tX ) \qquad Eq . ( 2 )$$

$${tX}^{′} = DeQuant ( {tX}_{q} ) \qquad Eq . ( 3 )$$

$$iX = {tX}^{′} \cdot K \qquad Eq . ( 4 )$$

According to an aspect of the disclosure, the techniques for vector quantization (VQ) based transform coefficient compensation can use a codebook (also referred to as a lookup table) to perform transform coefficients compensation. The codebook (lookup table) includes a plurality of codewords that associate keys (e.g., key vectors) with compensation terms (also referred to as compensation values, compensation value vectors and the like). The codebook can be searched based on the keys to find a closest key, and the compensation term associated with the closest key can represent the compensation term for compensating transform coefficients in the frequency domain (also referred to as spectrum domain). It is noted that in some examples, the compensation term associated with the closest key can represent compensation term for compensating residual block in the spatial domain.

In some aspects, a decoder can look up into the codebook to find the best candidate codeword to compensate a current block. When the candidate codeword is found and satisfy all criteria, decoder performs compensation for the current block based on the information read from the codebook in some examples.

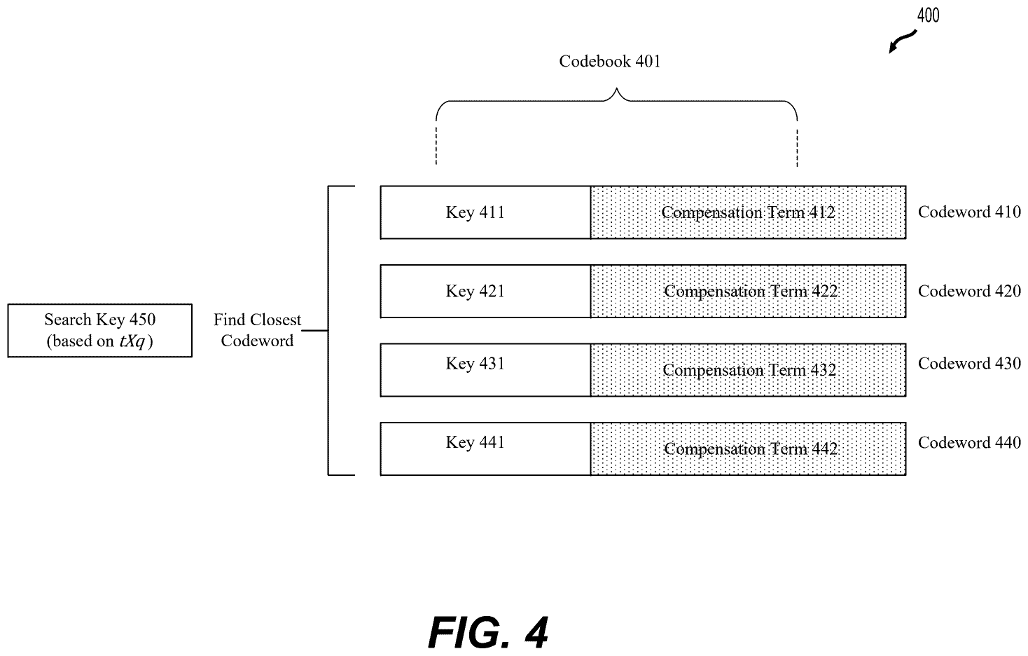

FIG. 4 shows an example of a framework (400) for using a codebook for transform coefficient compensation in some embodiments. In the framework (400), a codebook (401) is available to both encoder and decoder. The codebook (401) can be obtained by offline training. The codebook (401) includes a plurality of codewords, such as a first codeword (410), a second codeword (420), a third codeword (430), a fourth codeword (440) in FIG. 4. In some examples, each codeword includes a key and a compensation term. For example, the first codeword (410) includes a key (411) and a compensation term (412), the second codeword (420) includes a key (421) and a compensation term (422), the third codeword (430) includes a key (431) and a compensation term (432), the fourth codeword (440) includes a key (441) and a compensation term (442).

In some examples, the keys in FIG. 4 are vectors, and the compensation terms in FIG. 4 are also vectors.

In some examples, at the decoder side, when the quantized transform coefficients tX_{q} or the dequantized transform coefficients tX′ are obtained, a search key (e.g., a search key vector) (450) can be obtained based on the quantized transform coefficients tX_{q}, or the dequantized transform coefficients tX′. In some examples, the search key (450) is used to search the codebook (401) to find a closest codeword. For examples, distances of the search key (450) to the respective keys (411), (421), (431) and (441) can be calculated, and the codeword with a key having the shortest distance to the search key (450) can be the closest codeword. Then, the compensation term in the closest codeword can be used for the transform coefficient compensation of the quantized transform coefficients tX_{q} or the dequantized transform coefficients tX′ in some examples.

According to an aspect of the disclosure, the search key (e.g., search key vector) is composed by information available at the decoder side.

In some embodiments, a subset of the quantized transformed residues (also referred to as quantized transform coefficients tX) of the current block can be used to form the search key for searching the codebook.

In some embodiments, specific frequencies are selected to form the search key and the search key is used to find the closest record (also referred to as the closest codeword) in the codebook. For example, a subset of quantized transform coefficients tX_{q} at specific frequencies are selected to form the search key (450) for searching the codebook (401), the subset of quantized transform coefficients tX_{q} at specific frequencies can be components of the search key (450).

In some embodiments, a continues sequence of frequencies is used to form a search key and another non overlapping continues sequence of frequencies is used as a value to be compensated. More specifically, for block of N elements, continuous frequencies from 0 to M<N (e.g., corresponding to low frequencies in the frequency domain) can be selected as the search key. In some examples, a subset of quantized transform coefficients tX_{q} at a continuous sequence of frequencies are selected to form (components of) the search key (450) for searching the codebook (401). When a codeword with a closest distance to the search key is found, the compensation term in the codeword can be applied to the quantized transform coefficients tX_{q} or the dequantized transform coefficients tX′ at frequencies that are non-overlapping with the continuous sequence of frequencies. In some examples, the quantized transform coefficients tX_{q} at a continuous sequence of low frequencies (e.g., from 0 to M corresponding to a frequency sequence of low frequencies) can be selected as the search key for searching the codebook (401) to find a codeword with a closest distance to the search key, and the compensation term in the codeword can be applied to the quantized transform coefficients tX_{q} or the dequantized transform coefficients tX′ at high frequencies (e.g., from M+1 to N corresponding to the frequency sequence of high frequencies) that are non-overlapping with the continuous sequence of low frequencies.

In some embodiments, the prediction block or other decoder side information, such as a size of the current block, a shape of the current block, a width of the current block, a height of the current block, and the like can be used to form the search key.

According to an aspect of the disclosure, the compensation term can be used to compensate the loss, such as the loss due to the zero out of the transform coefficients, the loss due to zeros of the tail part of quantized transform coefficients. In some examples, the compensation term includes compensation components in the form of a vector.

In some embodiments, the complement set of frequencies to the search key can be compensated. For example, in each codeword, (components of) the key of the codeword can correspond to a first subset of frequencies in the spectrum domain (frequency domain), and (components of) the compensation term of the codeword can correspond to a second subset of frequencies in the spectrum domain, the second subset is a complement set to the first subset in the spectrum domain (associated with a block size). In an example, the search key is formed based on the first subset of frequencies in the quantized transform coefficients tX_{q}, and when a closest codeword is found, the compensation term of the closest codeword can include compensation components for the quantized transform coefficients tX_{q} at the second subset of frequencies.

In some embodiments, there can be some overlap between the frequencies to be compensated and the frequencies used as key. For example, in each codeword, (components of) the key of the codeword can correspond to a first subset of frequencies in the spectrum domain (frequency domain), and (components of) the compensation term of the codeword can correspond to a second subset of frequencies in the spectrum domain. The second subset can have one or more overlapping frequences to the first subset. In an example, the search key is formed based on the first subset of frequencies in the quantized transform coefficients tX_{q}, and when a closest codeword is found, the compensation term of the closest codeword can include compensation components for the quantized transform coefficients tX_{q} at the second subset of frequencies.

In some embodiments, the entire frequency band can be compensated. For example, in each codeword, (components of) the key of the codeword can correspond to a first subset of frequencies in the spectrum domain (frequency domain), and (components of) the compensation term of the codeword can correspond to a second subset of frequencies in the spectrum domain. The second subset can be the entire frequency band. In an example, the search key is formed based on the quantized transform coefficients tX_{q} at the first subset of frequencies, and when a closest codeword is found, the compensation term of the closest codeword can include compensation components for the quantized transform coefficients tX_{q} at the second subset of frequencies which is the entire frequency band.

According to an aspect of the disclosure, with the search key available, search can provide the nearest key/keys (closest key or closest keys) to the search key.

In some embodiments, L1, L2 or Cosine distance/metrics can be used to determine whether the search key is close enough to certain codeword (e.g., close enough to the key of the codeword).

In some embodiments, Hamming distance can be used when some meta information, such as mode information, is used to compose the search key and the key in the codeword.

In some embodiments, a fast searching algorithm can be applied to speed up the codebook search/matching. In some examples, the codebook is organized into a tree to perform tree structured VQ search. In some examples, some binary representation can be generated to perform search.

According to an aspect of the disclosure, once the nearest key/keys are found, a quality check can be performed before applying the compensation process.

In some embodiments, when the distance of certain key/keys to the search key is/are less than a threshold, the compensation process is performed. Otherwise (e.g., the distance of certain key/keys to the search key is/are longer than the threshold), the compensation process is not performed.

In some embodiments, a block level flag is signal to indicate whether to perform the compensation process.

According to an aspect of the disclosure, with the qualified compensation term/terms available, compensation process is performed.

In some embodiments, the compensation process replaces subject values to the corresponding values from the codebook. The subject values can be values of the quantized transform coefficients or can be values of the dequantized transform coefficients. For example, when a codeword is a nearest codeword and also passes a quality check, the compensation term (a vector including compensation components) of the codeword can correspond to certain frequencies, and can be used to replace, for example quantized transform coefficients tX_{q} (e.g., decoded from the coded video bitstream) at the certain frequencies to generate the updated quantized transform coefficients. In another example, when a codeword is a nearest codeword and also passes a quality check, the compensation term (a vector including compensation components) of the codeword can correspond to certain frequencies, and can be used to replace, for example dequantized transform coefficients tX′ at the certain frequencies to generate the updated dequantized transform coefficients.

In some embodiments, the compensation process adds subject values to the corresponding values from the codebook. The subject values can be values of the quantized transform coefficients or can be values of the dequantized transform coefficients. For example, when a codeword is a nearest codeword and also passes a quality check, the compensation term of the codeword can correspond to certain frequencies, and can be added with, for example quantized transform coefficients tX_{q} (e.g., decoded from the coded video bitstream) at the certain frequencies to generate the updated quantized transform coefficients. In another example, when a codeword is a nearest codeword and also passes a quality check, the compensation term (a vector including compensation components) of the codeword can correspond to certain frequencies, and can be added with, for example dequantized transform coefficients tX′ at the certain frequencies to generate the updated dequantized transform coefficients.

In some embodiment, the compensation process refines subject values using the corresponding values from the codebook. The subject values can be values of the quantized transform coefficients or can be values of the dequantized transform coefficients. In some examples, the compensation term can be added to the original subject values with some weight. In an example, the strength of the compensation term can be determined by the subject values. For example, when a codeword is a nearest codeword and also passes a quality check, the compensation term of the codeword can correspond to certain frequencies, the compensation components of the compensation term and the quantized transform coefficients tX_{q} (e.g., decoded from the coded video bitstream) at the certain frequencies can be combined using weighted sum in an example to generate the updated quantized transform coefficients tX_{q}. In some examples, the strength of the compensation term (e.g., the weight for the compensation term) can be adjusted based on the quantized transform coefficients tX_{q} (e.g., decoded from the coded video bitstream) at the certain frequencies.

In some embodiments, when multiple compensation terms available, blending can be used to combine different compensation terms together. In some examples, two or more codewords are the nearest codewords and also pass a quality check, the compensation terms of the two or more codewords can correspond to certain frequencies, the compensation terms can be suitably blended (combined) to generate a blended compensation term, and the blended compensation term is used to generate the updated quantized transform coefficients tX_{q}.

In an example, the blending is performed based on a weighted sum with blending weights, and the blending weights can be decided by the distances from key matching process, such as the respective distances of the codewords to the search key.

According to an aspect of the disclosure, the compensation process can be performed under certain condition.

In some embodiments, a flag in SPS/picture-level/slice-level etc. can be used to control the usage of VQ based transform coefficient compensation.

In some embodiments, a block satisfy certain criteria can perform VQ based transform coefficient compensation. In an example, a block with certain intra/inter prediction mode can be compensated using VQ based transform coefficient compensation. In another example, a block with certain size and/or shape can be compensated using VQ based transform coefficient compensation.

According to an aspect of the disclosure, multiple codebooks can be available for one block size. In some embodiments, the selection of a codebook from the multiple codebooks can be determined based on decoder side available information. In an example, different transform types can have different codebooks. In another example, different prediction types can have different codebooks.

In some embodiments, the selection of a codebook from multiple codebooks can be signaled as a SPS/picture-level/slice-level etc. flag.

According to an aspect of the disclosure, pre-processing can be applied on the input to the key match process. In some examples, filtering is applied on the search key before finding the compensation term.

According to an aspect of the disclosure, post-processing can be applied on the compensated block. In some examples, filtering is applied on the compensated block (transform block or residue block).

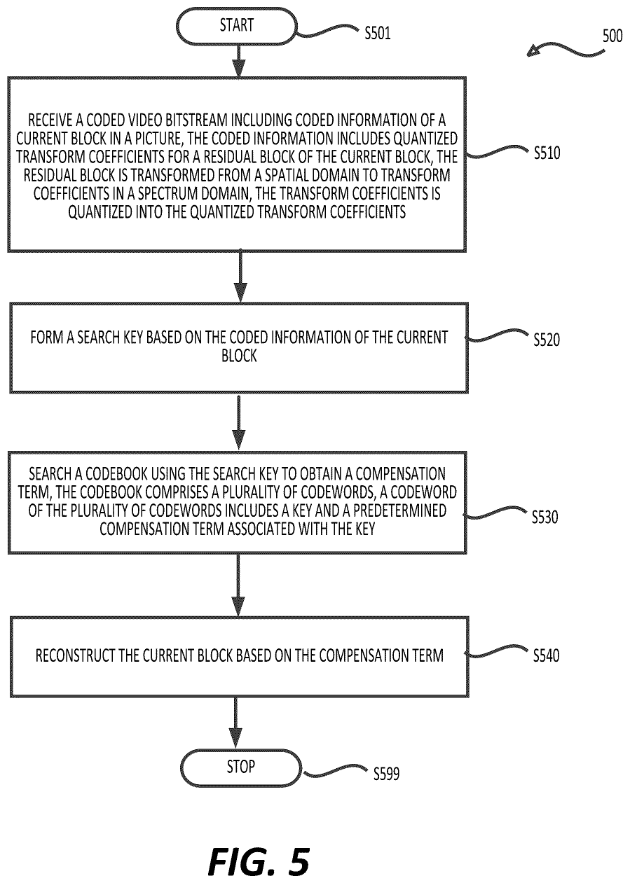

FIG. 5 shows a flow chart outlining a process (500) according to an aspect of the disclosure. The process (500) can be used in a video decoder. In various aspects, the process (500) is executed by processing circuitry, such as the processing circuitry that performs functions of the video decoder (110), the processing circuitry that performs functions of the video decoder (210), and the like. In some aspects, the process (500) is implemented in software instructions, thus when the processing circuitry executes the software instructions, the processing circuitry performs the process (500). The process starts at (S501) and proceeds to (S510).

At (S510), a coded video bitstream is received. The coded video bitstream includes coded information of a current block in a picture. The coded information includes quantized transform coefficients for a residual block of the current block, the residual block is transformed from a spatial domain to transform coefficients in a spectrum domain (also referred to as frequency domain), the transform coefficients are quantized into the quantized transform coefficients.

At (S520), a search key is formed based on the coded information of the current block.

At (S530), a codebook (also referred to as a lookup table) is searched (e.g., looked up) by using the search key to obtain a compensation term. The codebook includes a plurality of codewords, each codeword of the plurality of codewords (also referred to as records) includes a key and a predetermined compensation term associated with the key. The plurality of codewords can be pretrained according to an offline training process in an example.

At (S540), the current block is reconstructed based on the compensation term.

In some aspects, reconstructed transform coefficients are generated based on the quantized transform coefficients and the compensation term. An inverse transform is performed on the reconstructed transform coefficients to obtain a reconstructed residual block in the spatial domain, and the current block is reconstructed based on the reconstructed residual block.

In some examples, the search key is formed based on a subset of the quantized transform coefficients.

In some examples, the search key is formed based on a subset of the quantized transform coefficients that are at specific frequencies in the spectrum domain.

In some examples, the search key is formed based on a subset of the quantized transform coefficients at a continuous sequence of frequencies.

In some examples, the key of the codeword is a key vector that includes a plurality of components respectively corresponding to first frequencies of a first subset of frequencies in the spectrum domain, and the predetermined compensation term of the codeword is a compensation vector that includes a plurality of components respectively corresponding to second frequencies of a second subset of frequencies in the spectrum domain, the second subset of frequencies is a complement set of the first subset of frequencies.

In some examples, the key of the codeword is a key vector that includes a plurality of components respectively corresponding to first frequencies of a first subset of frequencies in the spectrum domain, and the predetermined compensation term of the codeword is a compensation vector that includes a plurality of components respectively corresponding to second frequencies of a second subset of frequencies in the spectrum domain, the second subset of frequencies has one or more overlapping frequencies with the first subset of frequencies.

In some examples, the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies covers an entire frequency band of the spectrum domain of the current block.

In some aspects, to search the codebook, a candidate codeword is determined from the plurality of codewords, the candidate codeword has a nearest key to the search key.

In some examples, the nearest key is determined based on at least one of: an L1 distance, an L2 distance, a cosine distance, or a hamming distance.

In some examples, the codebook is searched by using at least one of: a tree structured vector quantization (VQ) search algorithm; or a binary representation based search algorithm.

In some examples, a quality check is performed on the nearest key of the candidate codeword; and the compensation term is obtained from the candidate codeword when the nearest key passes the quality check. In an example, whether a distance of the search key and the nearest key is less than a threshold is checked. In another example, a block level flag of the current block is checked to determine whether the block level flag indicates whether to perform a compensation the VQ based transform coefficient compensation.

In some examples, the compensation term replaces corresponding subject values. For example, one or more reconstructed transform coefficients are generated based on only components of the compensation term without using a signaled value that is reconstructed based on a quantized transform coefficient.

In some examples, the compensation term is added to the corresponding subject values. For example, at least one reconstructed transform coefficient is generated based on a combination of a component of the compensation term and a signaled value that is reconstructed based on a quantized transform coefficient.

In some examples, at least one reconstructed transform coefficient is generated based on a weighted combination of a component of the compensation term and a signaled value that is reconstructed based on a quantized transform coefficient. In an example, a weight for the weighted combination is determined based on the signaled value.

In some aspects, a plurality of candidate codewords are determined from the plurality of codewords, and the compensation term is determined based on a blending of respective predetermined compensation terms of the plurality of candidate codewords. In an example, blending weights for the respective predetermined compensation terms are determined based on respective distances of the plurality of candidate codewords to the search key.

In an example, whether a flag is indicative of an allowance of a vector quantization based transform coefficient compensation is determined. In another example, whether the current block satisfies one of more conditions for applying a vector quantization based transform coefficient compensation is determined.

In some examples, the codebook is selected from a plurality of candidate codebooks that are available for a size of the current block. In an example, the codebook is selected based on a transform type of the current block. In another example, the codebook is selected based on a prediction mode of the current block. In another example, the codebook is selected based on a signal (e.g., a syntax element) in the coded video bitstream.

In some examples, a pre-processing is performed on the search key. For example, the search key is updated by filtering the search key.

In some examples, a post-processing is performed. For example, the reconstructed transform coefficients are updated by filtering the reconstructed transform coefficients.

Then, the process proceeds to (S599) and terminates.

The process (500) can be suitably adapted. Step(s) in the process (500) can be modified and/or omitted. Additional step(s) can be added. Any suitable order of implementation can be used.

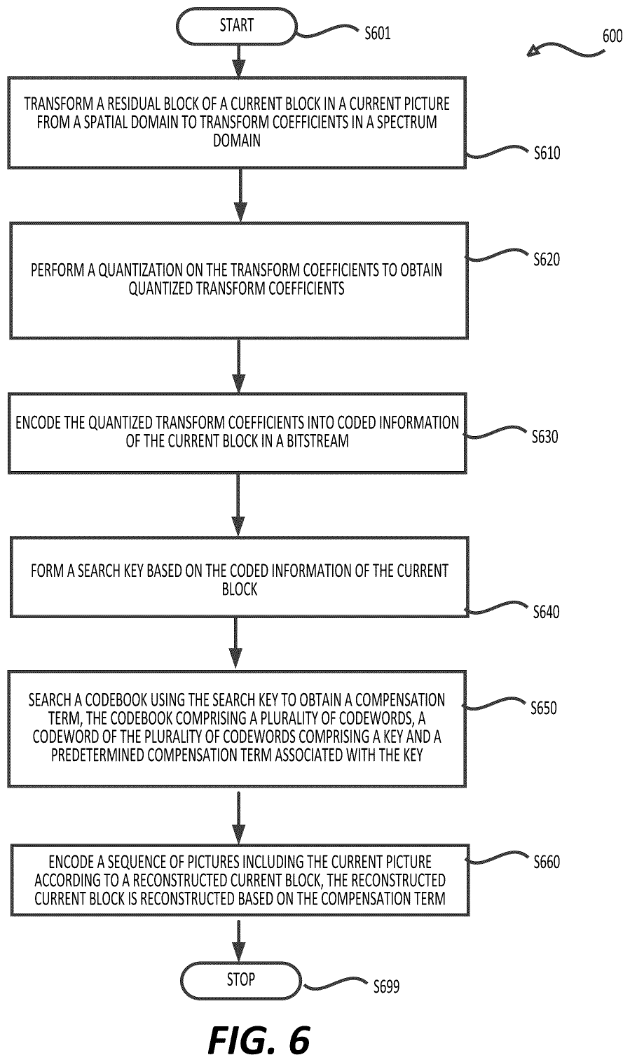

FIG. 6 shows a flow chart outlining a process (600) according to an aspect of the disclosure. The process (600) can be used in a video encoder. In various aspects, the process (600) is executed by processing circuitry, such as the processing circuitry that performs functions of the video encoder (103), the processing circuitry that performs functions of the video encoder (303), and the like. In some aspects, the process (600) is implemented in software instructions, thus when the processing circuitry executes the software instructions, the processing circuitry performs the process (600). The process starts at (S601) and proceeds to (S610).

At (S610), a residual block of a current block in a current picture is transformed from a spatial domain to transform coefficients in a spectrum domain.

At (S620), a quantization is performed on the transform coefficients to obtain quantized transform coefficients.

At (S630), the quantized transform coefficients are encoded into coded information of the current block in a bitstream (e.g., coded video bitstream).

At (S640), a search key is formed based on the coded information of the current block.

At (S650), a codebook is searched using the search key to obtain a compensation term, the codebook includes a plurality of codewords, a codeword of the plurality of codewords includes a key and a predetermined compensation term associated with the key.

At (S660), a sequence of pictures including the current picture are encoded according to a reconstructed current block, the reconstructed current block is reconstructed based on the compensation term.

In some examples, reconstructed transform coefficients are generated based on the quantized transform coefficient and the compensation term. An inverse transform is performed on the reconstructed transform coefficients to obtain a reconstructed residual block in the spatial domain. The reconstructed current block is generated based on the reconstructed residual block.

In some examples, the search key is formed based on a subset of the quantized transform coefficients.

In some examples, the search key is formed based on a subset of the quantized transform coefficients that are at specific frequencies in the spectrum domain.

In some examples, the search key is formed based on a subset of the quantized transform coefficients at a continuous sequence of frequencies.

In some examples, the key of the codeword is a key vector that includes a plurality of components respectively corresponding to first frequencies of a first subset of frequencies in the spectrum domain, and the predetermined compensation term of the codeword is a compensation vector that includes a plurality of components respectively corresponding to second frequencies of a second subset of frequencies in the spectrum domain, the second subset of frequencies is a complement set of the first subset of frequencies.

In some examples, the key of the codeword is a key vector that includes a plurality of components respectively corresponding to first frequencies of a first subset of frequencies in the spectrum domain, and the predetermined compensation term of the codeword is a compensation vector that includes a plurality of components respectively corresponding to second frequencies of a second subset of frequencies in the spectrum domain, the second subset of frequencies has one or more overlapping frequencies with the first subset of frequencies.

In some examples, the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies covers an entire frequency band of the spectrum domain of the current block.

In some aspects, to search the codebook, a candidate codeword is determined from the plurality of codewords, the candidate codeword has a nearest key to the search key. In some examples, the nearest key is determined based on at least one of: an L1 distance, an L2 distance, a cosine distance, or a hamming distance.

In some examples, the codebook is searched by using at least one of: a tree structured vector quantization (VQ) search algorithm; or a binary representation based search algorithm.

In some examples, a quality check is performed on the nearest key of the candidate codeword; and the compensation term is obtained from the candidate codeword when the nearest key passes the quality check. In an example, whether a distance of the search key and the nearest key is less than a threshold is checked. In another example, a block level flag of the current block that indicates whether to perform a compensation the VQ based transform coefficient compensation is encoded into the bitstream.

In some examples, the compensation term replaces corresponding subject values. For example, one or more reconstructed transform coefficients are generated based on only components of the compensation term.

In some examples, the compensation term is added to the corresponding subject values. For example, at least one reconstructed transform coefficient is generated based on a combination of a component of the compensation term and a value that is reconstructed based on a quantized transform coefficient.

In some examples, at least one reconstructed transform coefficient is generated based on a weighted combination of a component of the compensation term and a value that is reconstructed based on a quantized transform coefficient. In an example, a value indicative of the weights for the weighted combination is encoded into the bitstream.

In some aspects, a plurality of candidate codewords are determined from the plurality of codewords, and the compensation term is determined based on a blending of respective predetermined compensation terms of the plurality of candidate codewords. In an example, blending weights for the respective predetermined compensation terms are determined based on respective distances of the plurality of candidate codewords to the search key.

In an example, a flag that indicates an allowance of a vector quantization based transform coefficient compensation is encoded into the bitstream. In another example, whether the current block satisfies one of more conditions for applying a vector quantization based transform coefficient compensation is determined.

In some examples, the codebook is selected from a plurality of candidate codebooks that are available for a size of the current block. In an example, the codebook is selected based on a transform type of the current block. In another example, the codebook is selected based on a prediction mode of the current block. In another example, a signal that indicates the selection of the codebook from the plurality of candidate codebooks is encoded into the bitstream.

In some examples, a pre-processing is performed on the search key. For example, the search key is updated by filtering the search key.

In some examples, a post-processing is performed. For example, the reconstructed transform coefficients are updated by filtering the reconstructed transform coefficients.

Then, the process proceeds to (S699) and terminates.

The process (600) can be suitably adapted. Step(s) in the process (600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a block in a picture, the coded information includes quantized transform coefficients for a residual block of the current block, the residual block is transformed from a spatial domain to transform coefficients in a spectrum domain, the transform coefficients is quantized into the quantized transform coefficients. The format rule specifies that: a search key is formed based on the coded information of the current block; a codebook is searched using the search key to obtain a compensation term, the codebook comprises a plurality of codewords, a codeword of the plurality of codewords comprising a key and a predetermined compensation term associated with the key; and the current block is reconstructed based on the compensation term.

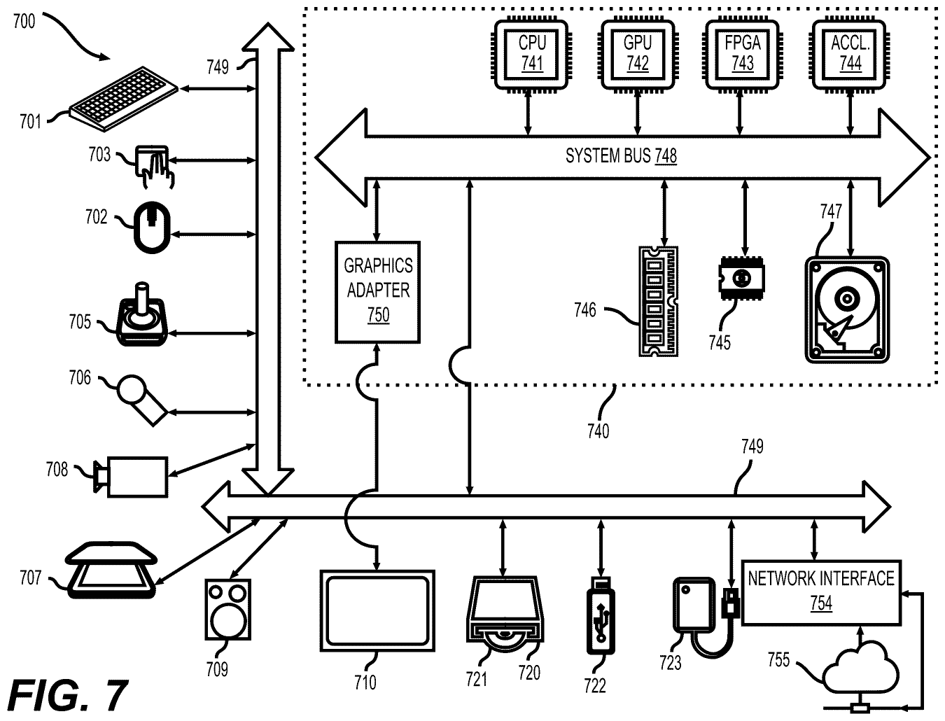

The techniques described above, can be implemented as computer software using computer-readable instructions and physically stored in one or more computer-readable media. For example, FIG. 7 shows a computer system (700) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system (700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (700).

Computer system (700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (701), mouse (702), trackpad (703), touch screen (710), data-glove (not shown), joystick (705), microphone (706), scanner (707), camera (708).

Computer system (700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (710), data-glove (not shown), or joystick (705), but there can also be tactile feedback devices that do not serve as input devices), audio output devices (such as: speakers (709), headphones (not depicted)), visual output devices (such as screens (710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (700) can also include human accessible storage devices and their associated media such as optical media including CD/DVD ROM/RW (720) with CD/DVD or the like media (721), thumb-drive (722), removable hard drive or solid state drive (723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (700) can also include an interface (754) to one or more communication networks (755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (749) (such as, for example USB ports of the computer system (700)); others are commonly integrated into the core of the computer system (700) by attachment to a system bus as described below (for example Ethernet interface into a PC computer system or cellular network interface into a smartphone computer system). Using any of these networks, computer system (700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (740) of the computer system (700).

The core (740) can include one or more Central Processing Units (CPU) (741), Graphics Processing Units (GPU) (742), specialized programmable processing units in the form of Field Programmable Gate Arcas (FPGA) (743), hardware accelerators for certain tasks (744), graphics adapters (750), and so forth. These devices, along with Read-only memory (ROM) (745), Random-access memory (746), internal mass storage such as internal non-user accessible hard drives, SSDs, and the like (747), may be connected through a system bus (748). In some computer systems, the system bus (748) can be accessible in the form of one or more physical plugs to enable extensions by additional CPUs, GPU, and the like. The peripheral devices can be attached either directly to the core's system bus (748), or through a peripheral bus (749). In an example, the screen (710) can be connected to the graphics adapter (750). Architectures for a peripheral bus include PCI, USB, and the like.

CPUs (741), GPUs (742), FPGAs (743), and accelerators (744) can execute certain instructions that, in combination, can make up the aforementioned computer code. That computer code can be stored in ROM (745) or RAM (746). Transitional data can also be stored in RAM (746), whereas permanent data can be stored for example, in the internal mass storage (747). Fast storage and retrieve to any of the memory devices can be enabled through the use of cache memory, that can be closely associated with one or more CPU (741), GPU (742), mass storage (747), ROM (745), RAM (746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (700), and specifically the core (740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (740) that are of non-transitory nature, such as core-internal mass storage (747) or ROM (745). The software implementing various aspects of the present disclosure can be stored in such devices and executed by core (740). A computer-readable medium can include one or more memory devices or chips, according to particular needs. The software can cause the core (740) and specifically the processors therein (including CPU, GPU, FPGA, and the like) to execute particular processes or particular parts of particular processes described herein, including defining data structures stored in RAM (746) and modifying such data structures according to the processes defined by the software. In addition or as an alternative, the computer system can provide functionality as a result of logic hardwired or otherwise embodied in a circuit (for example: accelerator (744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of”′ does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a current block in a picture, the coded information including quantized transform coefficients for a residual block of the current block, the residual block being transformed from a spatial domain to transform coefficients in a spectrum domain, the transform coefficients being quantized into the quantized transform coefficients; forming a search key based on the coded information of the current block; searching a codebook using the search key to obtain a compensation term, the codebook includes a plurality of codewords, a codeword of the plurality of codewords including a key and a predetermined compensation term associated with the key; and reconstructing the current block based on the compensation term.
(2). The method of feature (1), in which the reconstructing includes: generating reconstructed transform coefficients based on the quantized transform coefficients and the compensation term; performing an inverse transform on the reconstructed transform coefficients to obtain a reconstructed residual block; and reconstructing the current block based on the reconstructed residual block.
(3). The method of any of features (1) to (2), in which the forming the search key includes: forming the search key based on a subset of the quantized transform coefficients.
(4). The method of any of features (1) to (3), in which the forming the search key includes: forming the search key based on a subset of the quantized transform coefficients that are at specific frequencies in the spectrum domain.
(5). The method of any of features (1) to (4), in which the forming the search key includes: forming the search key based on a subset of the quantized transform coefficients at a continuous sequence of frequencies.
(6). The method of any of features (1) to (5), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies is a complement set of the first subset of frequencies.
(7). The method of any of features (1) to (6), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies has one or more overlapping frequencies with the first subset of frequencies.
(8). The method of any of features (1) to (7), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies covers an entire frequency band of the spectrum domain.
(9). The method of any of features (1) to (8), in which the searching the codebook includes: determining a candidate codeword from the plurality of codewords, the candidate codeword having a nearest key to the search key.
(10). The method of any of features (1) to (9), in which the nearest key is determined based on at least one of: an L1 distance, an L2 distance, a cosine distance, or a hamming distance.
(11). The method of any of features (1) to (10), in which the codebook is searched by using at least one of: a tree structured vector quantization (VQ) search algorithm; or a binary representation based search algorithm.
(12). The method of any of features (1) to (11), further including: performing a quality check on the nearest key of the candidate codeword; and obtaining the compensation term from the candidate codeword when the nearest key passes the quality check.
(13). The method of any of features (1) to (12), in which the performing the quality check includes at last one of: checking whether a distance of the search key and the nearest key is less than a threshold; or determining that a block level flag of the current block indicates whether to perform a compensation.
(14). The method of any of features (1) to (13), in which the generating the reconstructed transform coefficients includes: generating one or more reconstructed transform coefficients based on components of the compensation term.
(15). The method of any of features (1) to (14), in which the generating the reconstructed transform coefficients includes: generating at least one reconstructed transform coefficient based on a combination of a component of the compensation term and a signaled value that is reconstructed based on a quantized transform coefficient.
(16). The method of any of features (1) to (15), in which the generating the reconstructed transform coefficients includes: generating at least one reconstructed transform coefficient based on a weighted combination of a component of the compensation term and a signaled value that is reconstructed based on a quantized transform coefficient.
(17). The method of any of features (1) to (16), in which a weight for the weighted combination is determined based on the signaled value.
(18). The method of any of features (1) to (17), further including: determining a plurality of candidate codewords from the plurality of codewords; and generating the compensation term based on a blending of respective predetermined compensation terms of the plurality of candidate codewords.
(19). The method of any of features (1) to (18), in which the generating the compensation term includes: determining blending weights for the respective predetermined compensation terms based on respective distances of the plurality of candidate codewords to the search key.
(20). The method of any of features (1) to (19), further including at least one of: determining whether a flag is indicative of allowance of a vector quantization based transform coefficient compensation; or determining whether the current block satisfies one of more conditions for applying a vector quantization based transform coefficient compensation.
(21). The method of any of features (1) to (20), further including: selecting the codebook from a plurality of candidate codebooks that are available for a size of the current block.
(22). The method of any of features (1) to (21), in which the selecting includes at least one of: selecting the codebook based on a transform type of the current block; selecting the codebook based on a prediction mode of the current block; or selecting the codebook based on a signal in the coded video bitstream.
(23). The method of any of features (1) to (22), in which the forming the search key includes: updating the search key by filtering the search key.
(24). The method of any of features (1) to (23), in which the generating the reconstructed transform coefficients includes: updating the reconstructed transform coefficients by filtering the reconstructed transform coefficients.
(25). A method of video encoding, including: transforming a residual block of a current block in a current picture from a spatial domain to transform coefficients in a spectrum domain; performing a quantization on the transform coefficients to obtain quantized transform coefficients; encoding the quantized transform coefficients into coded information of the current block in a bitstream; forming a search key based on the coded information of the current block; searching a codebook using the search key to obtain a compensation term, the codebook including a plurality of codewords, a codeword of the plurality of codewords including a key and a predetermined compensation term associated with the key; and encoding, into the bitstream, a sequence of pictures including the current picture according to a reconstructed current block, the reconstructed current block being reconstructed based on the compensation term.
(26). The method of feature (25), further including: generating reconstructed transform coefficients based on the quantized transform coefficient and the compensation term; performing an inverse transform on the reconstructed transform coefficients to obtain a reconstructed residual block; and generating the reconstructed current block based on the reconstructed residual block.
(27). The method of any of features (25) to (26), in which the forming the search key includes: forming the search key based on a subset of the quantized transform coefficients.
(28). The method of any of features (25) to (27), in which the forming the search key includes: forming the search key based on a subset of the quantized transform coefficients that are at specific frequencies in the spectrum domain.
(29). The method of any of features (25) to (28), in which the forming the search key includes: forming the search key based on a subset of the quantized transform coefficients at a continuous sequence of frequencies.
(30). The method of any of features (25) to (29), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies is a complement set of the first subset of frequencies.
(31). The method of any of features (25) to (30), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies has one or more overlapping frequencies with the first subset of frequencies.
(32). The method of any of features (25) to (31), in which: the key of the codeword is a key vector that includes a plurality of components respectively corresponding to first frequencies of a first subset of frequencies in the spectrum domain; and the predetermined compensation term of the codeword is a compensation vector that includes a plurality of components respectively corresponding to second frequencies of a second subset of frequencies in the spectrum domain, the second subset of frequencies covers an entire frequency band of the spectrum domain.
(33). The method of any of features (25) to (32), in which the searching the codebook includes: determining a candidate codeword from the plurality of codewords, the candidate codeword having a nearest key to the search key.
(34). The method of any of features (25) to (33), in which the nearest key is determined based on at least one of: an L1 distance, an L2 distance, a cosine distance, or a hamming distance.
(35). The method of any of features (25) to (34), in which the codebook is searched by using at least one of: a tree structured vector quantization (VQ) search algorithm; or a binary representation based search algorithm.
(36). The method of any of features (25) to (35), further including: performing a quality check on the nearest key of the candidate codeword; and obtaining the compensation term from the candidate codeword when the nearest key passes the quality check.
(37). The method of any of features (25) to (36), in which the performing the quality check includes: checking whether a distance of the search key and the nearest key is less than a threshold; and encoding, in the bitstream, a block level flag of the current block to indicate whether to perform a compensation based on the checking.
(38). The method of any of features (25) to (37), in which the generating the reconstructed transform coefficients includes: generating one or more reconstructed transform coefficients based on components of the compensation term.
(39). The method of any of features (25) to (38), in which the generating the reconstructed transform coefficients includes: generating at least one reconstructed transform coefficient based on a combination of a component of the compensation term and a signaled value that is reconstructed based on a quantized transform coefficient.
(40). The method of any of features (25) to (39), in which the generating the reconstructed transform coefficients includes: generating at least one reconstructed transform coefficient based on a weighted combination of a component of the compensation term and a signaled value that is reconstructed based on a quantized transform coefficient.
(41). The method of any of features (25) to (40), in which a weight for the weighted combination is determined based on the signaled value.
(42). The method of any of features (25) to (41), further including: determining a plurality of candidate codewords from the plurality of codewords; and generating the compensation term based on a blending of respective predetermined compensation terms of the plurality of candidate codewords.
(43). The method of any of features (25) to (42), in which the generating the compensation term includes: determining blending weights for the respective predetermined compensation terms based on respective distances of the plurality of candidate codewords to the search key.
(44). The method of any of features (25) to (43), further including: encoding, into the bitstream, a flag that indicates whether a vector quantization based transform coefficient compensation is allowed.
(45). The method of any of features (25) to (44), further including: determining whether the current block satisfies one of more conditions for applying a vector quantization based transform coefficient compensation.
(46). The method of any of features (25) to (45), further including: selecting the codebook from a plurality of candidate codebooks that are available for a size of the current block.
(47). The method of any of features (25) to (46), in which the selecting includes at least one of: selecting the codebook based on a transform type of the current block; or selecting the codebook based on a prediction mode of the current block.
(48). The method of any of features (25) to (47), further including: encoding a signal in the bitstream, the signal being indicative of a selection of the codebook from the plurality of candidate codebooks.
(49). The method of any of features (25) to (48), in which the forming the search key includes: updating the search key by filtering the search key.
(50). The method of any of features (25) to (49), in which the generating the reconstructed transform coefficients includes: updating the reconstructed transform coefficients by filtering the reconstructed transform coefficients.
(51). A method of processing visual media data, the method including: processing a bitstream that includes the visual media data according to a format rule, in which: the bitstream carries coded information of a current block in a picture, the coded information includes quantized transform coefficients for a residual block of the current block the residual block is transformed from a spatial domain to transform coefficients in a spectrum domain, the transform coefficients are quantized into the quantized transform coefficients. The format rule specifies that a search key is formed based on the coded information of the current block; a codebook is searched using the search key to obtain a compensation term, the codebook includes a plurality of codewords, a codeword of the plurality of codewords includes a key and a predetermined compensation term associated with the key; and the current block is reconstructed based on the compensation term.
(52). A non-transitory computer readable medium storing a video media bitstream that is encoded by an encoding method, the encoding method comprising: transforming a residual block of a current block in a current picture from a spatial domain to transform coefficients in a spectrum domain; performing a quantization on the transform coefficients to obtain quantized transform coefficients; encoding the quantized transform coefficients into coded information of the current block in the video media bitstream; forming a search key based on the coded information of the current block; searching a codebook using the search key to obtain a compensation term, the codebook including a plurality of codewords, a codeword of the plurality of codewords including a key and a predetermined compensation term associated with the key; and encoding, into the video media bitstream, a sequence of pictures including the current picture according to a reconstructed current block, the reconstructed current block being reconstructed based on the compensation term.
(53). An apparatus of video decoding, including processing circuitry that is configured to perform the method of any of features (1) to (24).
(54). An apparatus for video encoding, including processing circuitry that is configured to perform the method of any of features (25) to (50).
(55). A non-transitory computer-readable storage medium storing instructions which when executed by at least one processor cause the at least one processor to perform the method of any of features (1) to (51).

What is claimed is:

1. A method of video decoding, comprising:
receiving a coded video bitstream comprising coded information of a current block in a picture, the coded information including quantized transform coefficients for a residual block of the current block, the residual block being transformed from a spatial domain to transform coefficients in a spectrum domain, the transform coefficients being quantized into the quantized transform coefficients;
forming a search key based on the coded information of the current block;
searching a codebook using the search key to obtain a compensation term, the codebook comprises a plurality of codewords, a codeword of the plurality of codewords comprising a key and a predetermined compensation term associated with the key; and
reconstructing the current block based on the compensation term.

2. The method of claim 1, wherein the reconstructing comprises:
generating reconstructed transform coefficients based on the quantized transform coefficients and the compensation term;
performing an inverse transform on the reconstructed transform coefficients to obtain a reconstructed residual block; and
reconstructing the current block based on the reconstructed residual block.

3. The method of claim 1, wherein the forming the search key comprises:
forming the search key based on a subset of the quantized transform coefficients.

4. The method of claim 1, wherein the forming the search key comprises:
forming the search key based on a subset of the quantized transform coefficients that are at specific frequencies in the spectrum domain.

5. The method of claim 1, wherein the forming the search key comprises:
forming the search key based on a subset of the quantized transform coefficients at a continuous sequence of frequencies.

6. The method of claim 1, wherein:
the key of the codeword is a key vector that includes a plurality of components respectively corresponding to first frequencies of a first subset of frequencies in the spectrum domain; and
the predetermined compensation term of the codeword is a compensation vector that includes a plurality of components respectively corresponding to second frequencies of a second subset of frequencies in the spectrum domain, the second subset of frequencies is a complement set of the first subset of frequencies.

7. The method of claim 1, wherein:
the key of the codeword is a key vector that includes a plurality of components respectively corresponding to first frequencies of a first subset of frequencies in the spectrum domain; and
the predetermined compensation term of the codeword is a compensation vector that includes a plurality of components respectively corresponding to second frequencies of a second subset of frequencies in the spectrum domain, the second subset of frequencies has one or more overlapping frequencies with the first subset of frequencies.

8. The method of claim 1, wherein:
the key of the codeword is a key vector that includes a plurality of components respectively corresponding to first frequencies of a first subset of frequencies in the spectrum domain; and
the predetermined compensation term of the codeword is a compensation vector that includes a plurality of components respectively corresponding to second frequencies of a second subset of frequencies in the spectrum domain, the second subset of frequencies covers an entire frequency band of the spectrum domain.

9. The method of claim 1, wherein the searching the codebook comprises:
determining a candidate codeword from the plurality of codewords, the candidate codeword having a nearest key to the search key.

10. The method of claim 9, wherein the nearest key is determined based on at least one of:
an L1 distance,
an L2 distance,
a cosine distance, or
a hamming distance.

11. The method of claim 9, wherein the codebook is searched by using at least one of:
a tree structured vector quantization (VQ) search algorithm; or
a binary representation based search algorithm.

12. The method of claim 9, further comprising:
performing a quality check on the nearest key of the candidate codeword; and
obtaining the compensation term from the candidate codeword when the nearest key passes the quality check.

13. The method of claim 12, wherein the performing the quality check comprises at last one of:
checking whether a distance of the search key and the nearest key is less than a threshold; or
determining that a block level flag of the current block indicates whether to perform a compensation.

14. The method of claim 2, wherein the generating the reconstructed transform coefficients comprises:
generating one or more reconstructed transform coefficients based on components of the compensation term.

15. The method of claim 2, wherein the generating the reconstructed transform coefficients comprises:
generating at least one reconstructed transform coefficient based on a combination of a component of the compensation term and a signaled value that is reconstructed based on a quantized transform coefficient.

16. The method of claim 2, wherein the generating the reconstructed transform coefficients comprises:
generating at least one reconstructed transform coefficient based on a weighted combination of a component of the compensation term and a signaled value that is reconstructed based on a quantized transform coefficient.

17. The method of claim 16, wherein a weight for the weighted combination is determined based on the signaled value.

18. The method of claim 9, further comprising:
determining a plurality of candidate codewords from the plurality of codewords; and
generating the compensation term based on a blending of respective predetermined compensation terms of the plurality of candidate codewords.

19. A method of video encoding, comprising:
transforming a residual block of a current block in a current picture from a spatial domain to transform coefficients in a spectrum domain;
performing a quantization on the transform coefficients to obtain quantized transform coefficients;
encoding the quantized transform coefficients into coded information of the current block in a bitstream;
forming a search key based on the coded information of the current block;
searching a codebook using the search key to obtain a compensation term, the codebook comprising a plurality of codewords, a codeword of the plurality of codewords comprising a key and a predetermined compensation term associated with the key; and
encoding, into the bitstream, a sequence of pictures including the current picture according to a reconstructed current block, the reconstructed current block being reconstructed based on the compensation term.

20. A non-transitory computer-readable storage medium storing instructions which when executed by a processor cause the processor to perform an encoding method, the encoding method comprising:
transforming a residual block of a current block in a current picture from a spatial domain to transform coefficients in a spectrum domain;
performing a quantization on the transform coefficients to obtain quantized transform coefficients;
encoding the quantized transform coefficients into coded information of the current block in a bitstream;
forming a search key based on the coded information of the current block;
searching a codebook using the search key to obtain a compensation term, the codebook comprising a plurality of codewords, a codeword of the plurality of codewords comprising a key and a predetermined compensation term associated with the key;
encoding, into the bitstream, a sequence of pictures including the current picture according to a reconstructed current block, the reconstructed current block being reconstructed based on the compensation term; and
transmitting the bitstream.
